(19) United States
(12) Patent Application Publication
(10) Pub. No.: US 2008/0230246 A1
(43) Pub. Date: Sep. 25, 2008

(54) Rotatable head vibrating multifunctional device

(76) Inventor: Donte Dollar-Wright, Los Angeles, CA (US)

Correspondence Address: Donald W. Meeker;Patent Agent, 924 East Ocean Front #E, Newport Beach, CA, 92661, US

(21) Appl. No.: 11/726,951

(22) Filed: Mar. 23, 2007

(51) Int. Cl. B25F 1/02

(52) U.S. Cl. 173/29

(57) ABSTRACT

A portable cord-less hand-held device provides both a rotary movement and a vibration both together or each individually to a variety of heads. Each alternately removably attached to the handle of the device for performing a variety of functions requiring rotation or rotation and vibration simultaneously.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to hand held rotational devices and in particular to a portable cord-less hand-held device which provides both a rotary movement and a vibration both together or each individually to a variety of heads each alternately removably attached to the handle of the device for performing a variety of functions requiring rotation or rotation and vibration simultaneously, wherein the rotary motion combined with the vibration is beneficial to the function being performed.

2. Description of Related Art Including Information Disclosed Under 37 CFR 1.97 and 1.98

While there are many hand-held rotational devices performing a variety of functions and a number of devices having a vibration function, there is a need for a device which provides both a rotational head with a vibration added to the head particularly related to grooming.

Related to grooming, dread locks, originating mostly originating from the West Indies, and made popular by such artists as Bob Marley, Eddie Grant, and NFL player Ricky Williams to mention a few, started off as small twists that clung to the scalp or hung loose from the scalp depending on the length of the African hair. Jerry Rice in the NFL, and actor Eddie Murphy in the movie Dr Doolittle sported these small twists.

Currently, hair stylists wash the client's hair, saturate the hair with bees wax or other holding gel, cream, ointments or hair-holding concoctions of their choosing, they then insert a small comb into a pinch of hair and proceed to rotate the comb in their hands for approximately thirty to ninety seconds or for as long as the length of the client's hair dictates. With a client's head having in total up to as much as or in excess of one hundred individual twists, it is obviously time-consuming. Furthermore, the repetitive motion of twirling the comb through the fingers to effectuate the dread twist could have long-term effects on joints in the stylist's hands or wrists. The prior art has not adequately solved this problem.

There is also lacking a combined rotation and vibration device for simultaneous hair brushing and scalp massage for humans or pets, for washing and scrubbing and waxing, for cleaning, and a variety of other functions wherein such a device would be beneficial.

The following prior art patents do not solve the problems:

U.S. Pat. No. 5,725,000, issued Mar. 14, 1996 to Rice, indicates a hair curling device (10) which curls hair in less time and with less effort than utilizing ones hands.

U.S. Pat. No. 5,603,339, issued Mar. 16, 1995 to Brazeal et al, puts forth a device for engaging and twisting a lock of hair.

U.S. Pat. No. 6,314,966, issued Mar. 3, 2000 to Yokokawa, is for a rotating member connected through a motor shaft to a motor provided in a housing of the body.

U.S. Pat. No. 3,863,652, issued Aug. 31, 1973 to Scivoletto, describes a motor that is adapted to be electrically driven is mounted in a first, hollow housing together with a gear train that is coupled to and driven by the motor through a belt and pulley arrangement.

U.S. Pat. No. 6,109,275, issued Aug. 29, 2000 to Mendezmonsanto, is for a hair twisting device which has a pair of hair gripping holders which grip two wisps of hair, and which are rotatably mounted within a housing.

U.S. Pat. No. 6,318,378, issued Nov. 20, 2001 to Kennedy, discloses a hair styling device for twirling locks of hair together including a main body, and at least two hair grabbers for respectively grabbing separate locks of hair.

U.S. Pat. No. 6,499,491, issued Dec. 31, 2002 to Kennedy et al, provides a hair styling device for twirling locks of hair together including a main body, and at least two hair grabbers for respectively grabbing separate locks of hair.

U.S. Patent Application #20030192564, published Oct. 16, 2003 by Johnson et al, shows a light weight, hand-held automatic brush that is simple to operate.

U.S. Pat. No. 4,582,074, issued Apr. 15, 1983 to Schwager et al, is for a hair twining apparatus configured for one hand operation of a trigger, the apparatus having at least two hair clamp members carried by a sub-housing within a housing.

U.S. Pat. No. 4,583,561, issued Apr. 22, 1986 to Larsson, claims a hair twining apparatus configured for one hand operation of a trigger, the apparatus having at least two hair clamp members carried by a sub-housing within a housing.

U.S. Pat. No. 6,962,159, issued Sep. 7, 2002 to Adam, shows a cone mounted coaxially on a hand held motor.

U.S. Pat. No. 4,139,014, issued Feb. 13, 1979 to Rowland, illustrates a styling comb/hair curler combination comprising a housing having a motor, heating element, and blower therein efficiently and compactly arranged to reciprocate the comb or alternatively, heat the curling attachment.

U.S. Pat. No. 7,069,935, issued Jul. 4, 2006 to Boysen, is for a hair braider including a body having a handle and a head portion.

U.S. Pat. No. 6,520,187, issued Feb. 18, 2003 to Lee et al, provides a hair braider and its auxiliary device, which are portable and braids three bunches of hair into a strand.

Published U.S. Patent Application, Publication #2003-0230316 A1, published Dec. 18, 2003 by Glucksman, et al, indicates a hair braider kit.

U.S. Pat. No. 4,222,398, issued Sep. 16, 1980 to Fromman, puts forth an electrically powered device for curling hair including a power element containing handle housing portion and an angularly disposed, rotatable chucking device and spindle with a removable hair curler associated in driven relationship therewith.

U.S. Pat. No. 5,488,963, issued Feb. 6, 1996 to Fishman is for a hair twisting apparatus that includes a housing, a jaw assembly on the housing and a trigger on the housing which is operable for twisting the jaw assembly to twist a group of hair strands received therein.

U.S. Pat. No. 4,797,533, issued Jan. 10, 1989 to Santhouse, et al., describes a hair appliance that has a hair winding portion extending axially from the end of a handle covered by a flexible sleeve member adapted to be depressed in order to activate a movable part of the hair appliance.

U.S. Pat. No. 4,641,010, issued Feb. 3, 1987 to Abura, et al., is for an electric hair curler comprising a handle and a barrel connected thereto for winding thereabout the hair.

U.S. Pat. No. 4,280,517, issued Jul. 28, 1981 to Ihara, discloses a brush attachment including a plurality of brushes to hair dressers for performing curling treatment with respect to hairs wound around the attachment with hot or cool air stream blown from a dresser body.

U.S. Pat. No. 5,273,058, issued Dec. 28, 1993 to Edwards, provides a hair curling and styling tool for aiding the curling of hair thereabout as the tool is rotated by the handle.

U.S. Pat. No. 5,967,150. issued Oct. 19, 1999 to Wright, et al. shows a comb suitable for use as a teasing comb in hair styling that is motor-operated so that consistent, high quality results are obtained without tiring the service provider.

U.S. Pat. No. 3,894,549, issued Jul. 15, 1975 to Scivoletto, claims a drive motor that is adapted to be electrically driven with one or more combs or brushes, and a heater, a fan and a thermostat may be included in the first housing in order to heat the combs or brushes.

U.S. Pat. No. 3,474,795, issued Oct. 28, 1968 to Hantman, shows a hair dressing device having an electric motor and drive mechanism releasably connected to a comb for rapidly oscillating the comb about a longitudinal axis.

U.S. Pat. No. 3,461,883, issued Aug. 19, 1969 to Maris, illustrates a power hair comb apparatus, having a casing, a prime mover having a drive shaft contained therein.

U.S. Pat. No. 3,349,782, issued Oct. 31, 1967 to Sawin, is for a hair styling comb with driving means for mechanically performing hair styling operations such as back-combing or “teasing” and “French lacing.”

U.S. Pat. No. 3,204,469, issued Sep. 7, 1965 to Spillers, indicates a power operated teasing comb, having a releasably detachable comb which is driven in an elliptical or orbital path.

German Patent #DE19914878 C2, issued Apr. 3, 2003 to Jagst, puts forth a hairdressing hand appliance, to braid hair strands into pigtails, that gives a mechanical braiding action.

Published Japanese Patent Application, Publication #JP10033241 A, published Feb. 10, 1998 by TAKANO HISASHI provides a device to easily form the hair style of fine and natural waves in a short time.

Published International Patent Application, Publication #WO-2004-064568 A1, published Aug. 5, 2004, by Bousfield, et al., describes a hair braider for a three-bundle plait or braid that includes a body having a handle and a head portion at one end of the handle.

Published International Patent Application, Publication #WO-0154535 A1, published Aug. 2, 2001 by Jun, et al., is for a hair braider and its auxiliary device, which are portable and braids three bunches of hair into a strand.

Published British Patent Application, Publication #GB-2396105 A, published Jun. 16, 2004 by Sharpe, discloses a hair plaiting machine that is an electrically powered hand held device driving three rotating spindles in a “figure of eight” path.

Published European Patent #EP-1064866 B1, published Dec. 7, 2005 by Yokokawa, provides a hair perming device that includes a rotating member connected through a motor shaft to a motor provided in a housing of a body.

U.S. Pat. No. 5,832,939, issued Nov. 10, 1998 to Nathe, shows an improved hair waving appliance.

Published International Patent Application, Publication #WO-0122845 A1, published Apr. 5, 2001 by Wan, claims a hair braiding apparatus.

Published International Patent Application, Publication #WO-0156423 A1, published Aug. 9, 2001 by Kennedy, et al., and European Patent #EP-1164887 B1, issued Jan. 2, 2004 to Kennedy/Matsumoto Design LLC, et al., show a hair styling device for twirling locks of hair together including a main body, and at least two hair grabbers for respectively grabbing separate locks of hair.

British Patent, Publication #GB-589911 A, published Jul. 3, 1947 by Ace Electronics Ltd, et al., illustrates that hair is permanently curled or straightened by subjecting it to a high-frequency electric field between electrodes mounted on the handle of a hair curler or comb.

European Patent #EP-0030257 B1, issued Jun. 20, 1894 to Beisecker, et al., is for a hair waving appliance with a preferably cylindrical bar member, held at one end in a grip part and containing a heater, a fuel tank containing fuel for the heater.

Published European Patent Application, Publication #EP-1267661 A1, published Jan. 2, 2003 by Lee, et al. describes a hair braider and its auxiliary device, which are portable and braids three bunches of hair into a strand.

Published French Patent Application, Publication #FR-2872827 A1, published Jan. 13, 2006 by Kouassi is for a plaiting machine.

What is needed is a portable cord-less hand-held device which provides both a rotary movement and a vibration to a variety of heads each alternately removably attached to the handle of the device for performing a variety of functions wherein the rotary motion combined with the vibration is beneficial to the function being performed.

### BRIEF SUMMARY OF THE INVENTION

An object of the present invention is to provide a portable cord-less hand-held device which provides both a rotary movement and a vibration both simultaneously or separately to a variety of heads each alternately removably attached to the handle of the device for performing a variety of functions wherein the rotary motion combined with the vibration is beneficial to the function being performed.

In brief, the present invention comprises a hand held, battery powered revolving motor and vibrator attached to an assortment of detachable, single purpose heads one of which is an interchangeable comb head for hair styling, specifically for the purpose of twisting pinches of Afro-hair that could eventually turn into dread locks.

In addition to the comb-twist attachment, there is a series of other attachment heads. The series of attachment heads comprises some or all of the attachment heads taken from the list of attachment heads including a dread-lock twister head, a suede cleaner head, a vibrating human hair brush head, a dog grooming/massaging head, a shoe polisher head, a sneaker cleaner head, a silver/brass cleaner head, a dish/pot washer head, a crystal/wine glass polisher/dryer head, a static feather duster head, a car upholstery duster head, a car washer head, a car waxer head, a car polisher head, a wheel rim waxer and polisher head,

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a perspective view of the main body and one attachable head of the present invention aligned for attachment, showing the rotational motor and vibrator in the main body and an attachment head comprising a hair care device comprising a dreadlock comb;

FIG. 2 is an exploded perspective view showing the double locking mechanism of the present invention for attaching a head to the main body;

FIG. 3 is a perspective view of the main body a of the present invention showing the double lock housing aligned for attachment to the main body and showing the controls on the housing and an attachable recharging cord;

FIG. 4 is a perspective view of the main body of the device of the present invention with an attachable head comprising a dog grooming/massaging head with dog grooming bristles shown in action rotating and vibrating;

FIG. 5 is a perspective view of the main body of the device of the present invention with an attachable head comprising a vibrating human hair brush head with bristles for human hair shown in action rotating and vibrating;

FIG. 6 is a perspective view of the main body of the device of the present invention with an attachable head comprising a suede cleaner head with suede cleaning bristles shown in action rotating and vibrating;

FIG. 7 is a perspective view of the main body of the device of the present invention with an attachable head comprising a shoe polisher head with shoe polishing bristles and also a sneaker cleaner head with alternate sneaker cleaner bristles shown in action rotating and vibrating;

FIG. 8 is a side elevational view of an attachable head comprising a dish/pot washer head with washing bristles on bristle heads of plastic or metal which slide on or off for each task wherein the entire cleaning appendage can be dismantled just like vacuum cleaner attachments, to elongate or shorten etc.;

FIG. 9 is a perspective view of an attachable head comprising a wheel rim waxer and polisher head with a pointed soft end;

FIG. 10 is a side elevational view of an attachable head comprising a silver/brass cleaner head with cleaner bristles for cleaning metal formed of very soft silver buffing material, for buffing silverware and brass door knobs, banisters, etc.;

FIG. 11 is a perspective view of an attachable head comprising a crystal/wine glass polisher/dryer head with an egg-shell foam end;

FIG. 12 is a side elevational of an attachable head comprising a car washer and waxer head with a soft car washer and waxer surface;

FIG. 13 is a perspective view of an attaching sneaker cleaner spray guard which clips onto a pair of grooves in the main body;

FIG. 14 is a perspective view of an attachable head comprising a static feather duster head for electronic equipment and car interiors with feather duster feathers.

### DETAILED DESCRIPTION OF THE INVENTION

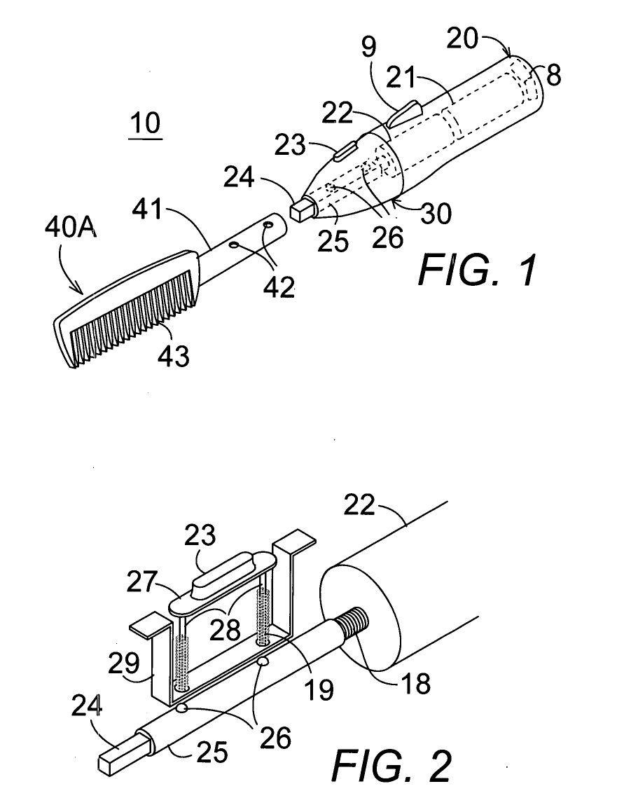

In FIGS. 1-14, a multi-functional hand-held electric tool device 10 comprises a main body 20 structured as a handle for housing a motor 22 for rotary motion and a vibrator 21 to produce vibration, both together or separately, to a series of removable heads 40A-40L for different functions wherein the function will benefit from rotary motion or combined rotary motion and vibration.

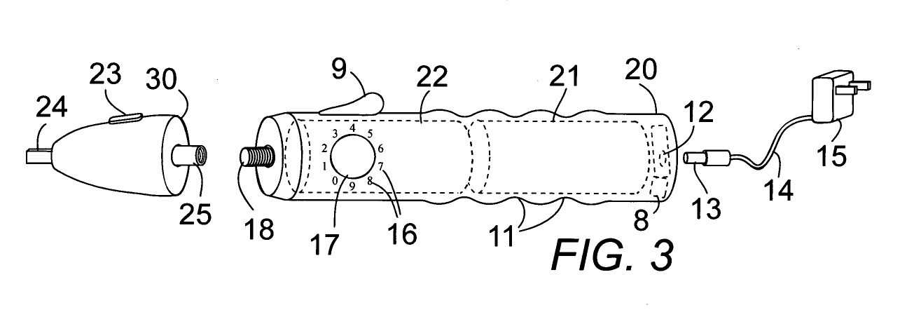

In FIGS. 1-3, the main body 20 is structured as a handle for the device to be held in a hand of a user. The main body comprises a housing for as electric motor 22 which produces a rotational motion to a drive shaft 18 with engages a locking mechanism shaft 25 which has a square engaging shaft 24 to connect to a removable head 40A-40L for rotating the head and a vibration device 21 for vibrating the head. In FIG. 3, a control switch 9 on the housing is used as a means for switching between a first mode with rotation alone, a second mode with rotation and vibration together and a third mode with vibration alone while activating and deactivating the device, another knob 17 with indicating indicia 16 is used as a means for adjusting the speed of the rotation and vibration.

The series of attachment heads 40A-40L are alternately and removably attached to the main body so that the electric motor imparts the rotation and vibration to the heads in an appropriate mode for each of the heads, as shown in FIGS. 4-7.

In FIG. 2, a tensioned dual locking means housed in a front cone-shaped compartment 30 for attaching each of the heads 40A-40L to the handle 20 is structured to withstand both rotation of the head and vibration of the head without separating from the handle. The dual locking means comprises a hollow cylindrical head shaft 41 extending from each of the attachment heads, the head shaft 41 having two longitudinally aligned spaced openings 42 therethrough and a handle attachment rod 25 having a pair of spring-loaded protrusions 26 to mate with the two mating openings in a head attaching shaft to lock each of the heads onto the handle and a spring-loaded button on the main body 20. The spring-loaded button 9 has a pair of spring loaded shafts 28 each having a spring 19, and each releasing one of the spring-loaded protrusions 26 to release the attachment head shaft 41 from the handle 20.

A rechargeable electric portable power source 8, such as a rechargeable battery, within a base of the main body 20 powers the device. The power source further comprises a device plug 13 means for attaching to a wire 14 and an outlet plug 15 into an external source of power for recharging the battery power source, with the device plug 13 connecting through an opening 12 in the main body 20.

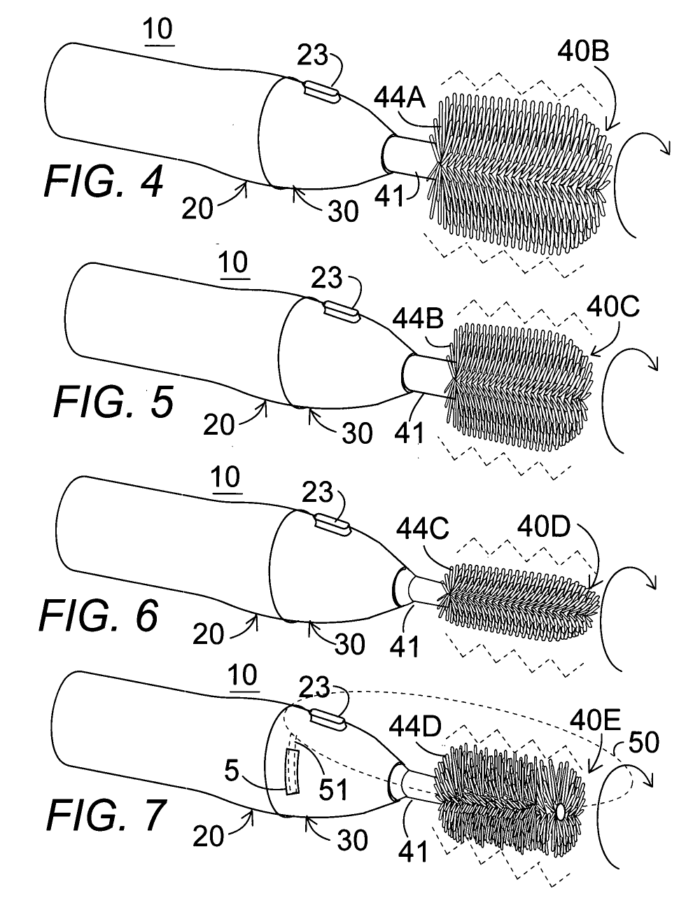

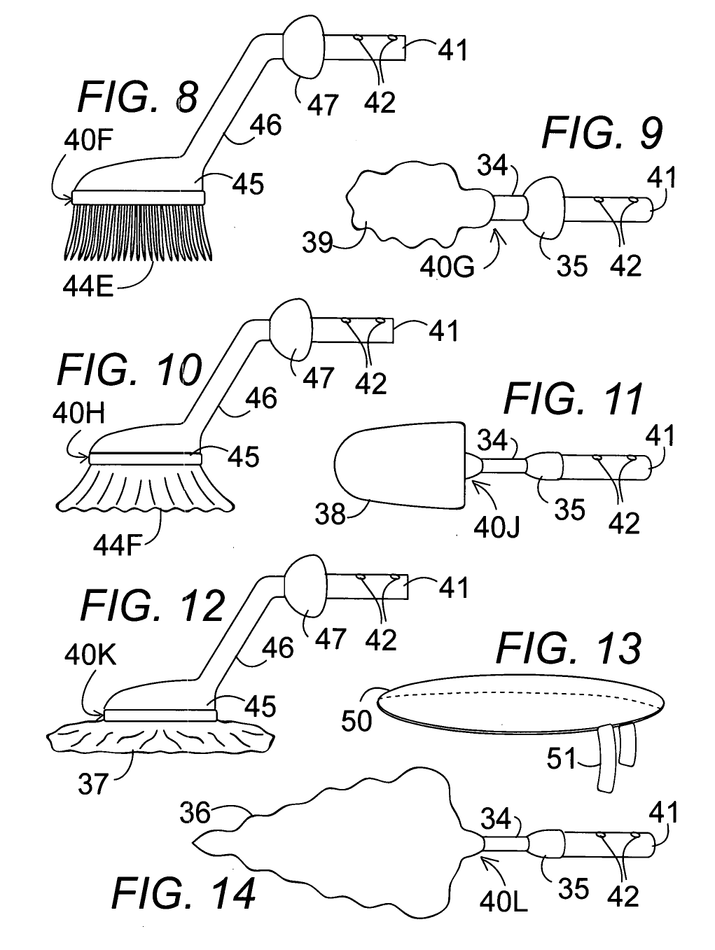

The series of attachment heads 40A-40L comprises some or all of the attachment heads taken from the list of attachment heads including a dread-lock twister head 40A with comb teeth 43 of FIG. 1, a suede cleaner head 40D with suede cleaning bristles 44C of FIG. 6, a vibrating human hair brush head 40C with bristles 44B of FIG. 5, a pet grooming/massaging head 40B with dog grooming bristles 44A of FIG. 4, a shoe polisher head 44D with shoe polishing bristles 44D of FIG. 7, a sneaker cleaner head 44D with alternate sneaker cleaner bristles of FIG. 7 and attaching sneaker cleaner spray guard 50 which clips onto a pair of grooves 5 in the main body by flexible arms 51 of FIG. 13, a silver/brass cleaner head 44F with cleaner bristles 44F for cleaning metal formed of very soft silver buffing material, for buffing silverware and brass door knobs, banisters, etc. of FIG. 10, a dish/pot washer head 40F with washing bristles 44E on plastic or metal heads which slide on and off of an arm which can be of various lengths of FIG. 8, a crystal/wine glass polisher/dryer head 40J with egg-shell foam end 38 of FIG. 11, a static feather duster head 40L for electronic equipment and car interiors with feather duster feathers 36 of FIG. 14, a car washer and waxer head 40K with a soft car washer and waxer surface 37 of FIG. 12, and a wheel rim waxer and polisher head 40F with a pointed soft end 39 of FIG. 9.

In FIGS. 4-7, the various attachment heads 40B-40D are shown attached to the main body 20 forming the handle with each of the heads rotating (arrow) and vibrating (dashed lines).

In FIGS. 1, and 4-7, the attaching heads 40A-40D each attach directly onto the main body 20.

In FIGS. 9, 11, and 14, the attaching heads 40G, 40J and 40L have an additional straight shaft 34 and coupling 35 between the head shaft 41 and the head.

In FIGS. 8, 10, and 12, the attaching heads 40F, 40H, and 40K each have an angled connecting shaft 46 with bottom housing 45 and top housing 47 for gear converts to translate the vertical rotation from the main body 20 into horizontal rotation of the head 40F, 40H, and 40K.

The attachments are simple and straightforward and can be made out of any material that simple combs are made out of plastic, alloys, synthetic fur, etc.

It is understood that the preceding description is given merely by way of illustration and not in limitation of the invention and that various modifications may be made thereto without departing from the spirit of the invention as claimed.

What is claimed is:

1. A multi-functional hand-held electric tool device comprising:
a main body structured as a handle for the device to be held in a hand of a user, the main body comprising a housing for as electric motor which produces a rotational motion and a vibration, and a means for adjusting the speed of the rotation and vibration and a means for switching between a first mode with rotation alone, a second mode with rotation and vibration together and a third mode with vibration alone having at least one control device on the handle for controlling the means for adjusting the speed of the rotation and vibration and the means for switching between modes;
a series of attachment heads alternately and removably attached to the main body so that the electric motor imparts the rotation and vibration to the heads in an appropriate mode for each of the heads;
a tensioned dual locking means for attaching each of the heads to the handle to with stand both rotation of the head and vibration of the head without separating from the handle;
a rechargeable electric portable power source within a base of the main body for powering the device, the power source comprising means for attaching to a wired source of power for recharging the power source.

2. The device of claim 1 wherein the dual locking means comprises a hollow cylindrical head shaft extending from each of the attachment heads, the head shaft having two longitudinally aligned spaced openings therethrough and a handle attachment rod having a pair of spring-loaded protrusions to mate with the two mating openings in a head attaching shaft to lock each of the heads onto the handle and a spring-loaded button on the main body, the spring-loaded button having a pair of spring loaded shafts each releasing one of the spring-loaded protrusions to release the attachment head shaft from the handle.

3. The device of claim 1 wherein means for adjusting the speed of the rotation and vibration comprises at least one switch turned to one of a plurality of speed settings.

4. The device of claim 1 wherein the series of attachment heads comprises some or all of the attachment heads taken from the list of attachment heads including a dread-lock twister head, a suede cleaner head, a vibrating human hair brush head, a dog grooming/massaging head, a shoe polisher head, a sneaker cleaner head, a silver/brass cleaner head, a dish/pot washer head, a crystal/wine glass polisher/dryer head, a static feather duster head for electronic equipment and vehicle interiors, a car washer and waxer head, and a wheel rim waxer and polisher head.

5. The device of claim 1 wherein one of the attachment heads comprises a dread-lock twister comprising a comb device.

6. The device of claim 1 wherein one of the attachment heads comprises a vibrating human hair brush comprising a cylindrical brush head with bristles to brush hair and massage scalp simultaneously.

7. The device of claim 1 wherein one of the attachment heads comprises a dog grooming and massaging head comprising a cylindrical brush head with bristles for simultaneously brushing and massaging a pet.

8. The device of claim 1 wherein one of the attachment heads comprises a suede cleaner head comprising a cylindrical brush head with bristles for cleaning suede.

9. The device of claim 1 wherein one of the attachment heads comprises a shoe polisher head comprising a cylindrical brush head with bristles for polishing shoes.

10. The device of claim 1 wherein one of the attachment heads comprises a sneaker cleaner head comprising a cylindrical brush head with bristles for cleaning sneakers.

11. The device of claim 10 further comprising a clip on spray guard for the sneaker cleaner.

12. The device of claim 1 wherein one of the attachment heads comprises a silver and brass cleaner and polisher head comprising a soft buffer head for cleaning and polishing silver and brass.

13. The device of claim 1 wherein one of the attachment heads comprises a dish and pot washer head comprising an angled handle with an out rotating brush head for scrubbing dishes and pots, the angled handle comprising a means for transmitting the rotation and vibration to the rotating brush head.

14. The device of claim 1 wherein one of the attachment heads comprises a feather duster head comprising an elongated feather duster head for static-free dusting of equipment.

15. The device of claim 1 wherein one of the attachment heads comprises a glass polisher and dryer head comprising an eggshell foam head for polishing and drying glasses.
